(19) United States
(12) Patent Application Publication
(10) Pub. No.: US 2013/0205964 A1
(43) Pub. Date: Aug. 15, 2013

(54) LABEL PRODUCING DEVICE

(71) Applicant: Seiichi Matsushita, Yamatotakada-shi (JP)

(72) Inventor: Seiichi Matsushita, Yamatotakada-shi (JP)

(73) Assignee: FUJI SEAL INTERNATIONAL, INC., Osaka-shi, Osaka (JP)

(21) Appl. No.: 13/879,927

(22) PCT Filed: Sep. 20, 2011
(86) PCT No.: PCT/JP2011/071298

§ 371 Date: Apr. 17, 2013

(30) Foreign Application Priority Data
Oct. 29, 2010 (JP) 2010-244267

(51) Int. Cl. B65C 9/00

(52) U.S. Cl. CPC B65C 9/0065
USPC 83/80; 83/367; 83/209

(57) ABSTRACT

The label producing device includes: a cutting device for cutting the elongated label base material for each label; a first feeding device disposed upstream of the cutting device with respect to the conveying direction of the label base material; a second feeding device disposed further upstream of the first feeding device; a mark sensor for detecting reference marks of each label on the label base material between the first feeding device and the second feeding device; and a control device for controlling the respective operations of the cutting device, the first feeding device and the second feeding device on the basis of a detection signal from the marker sensor. The control device separately controls each of the operations of a first feeding motor and a second feeding motor such that a first roller pair and a second roller pair rotate synchronously.

### BACKGROUND OF INVENTION

1. Filed of the Invention

The present invention generally relates to a label producing device, and particularly to a label producing device which produces a plurality of labels sequentially from an elongated label base material having a plurality of labels being sequenced thereon by cutting the label base material for each label while the label base material is conveyed in a longitudinal direction.

2. Description of the Related Art

Conventionally, a label feeding device such as a label feeding device 80 as shown in FIG. 12 has been disclosed in Japanese Laid-Open No.2009-234649 (Patent Document 1). The label feeding device 80 produces individual labels L sequentially by cutting a belt-like label base material S made of many tubular labels for each label L while the base material is conveyed in a longitudinal direction.

The label feeding device 80 includes a feeding mechanism 82, a cutting mechanism 84, a mark sensor 86, and a control means which is not shown. The feeding mechanism 82 includes a feed roller 83a and a follower roller 83b which is in contact with the feed roller under pressure. With the label base material S being gripped in a nip formed between the rollers 83a and 83b, these rollers are driven to rotate in a direction indicated by an arrow so that the label base material S is conveyed along an arrow 88.

The cutting mechanism 84 is provided to cut the label base material S into the individual labels L. The cutting mechanism 84 is made of a rotating blade 85a which rotates in a direction indicated by an arrow, and a fixed blade 85b disposed opposite to the rotating blade 85a across the gripped label base material S. In the cutting mechanism 84, the label material S, which is being fed to the downstream side of the feeding mechanism 82, is cut each time the rotating blade 85a rotates once to produce each label L.

The mark sensor 86 is made of an optical sensor, for example, and is disposed to face the label material S, which is being fed in a predetermined direction, upstream of the feeding mechanism 82. The mark sensor 86 detects a reference mark attached to each label L of the label base material S and sends a detection signal to the control means.

The control means controls the feeding speed of the feeding mechanism 82 in response to the detection signal supplied from the mark sensor 86. Specifically, the control means controls the feeding speed of the feeding mechanism 82 in order to adjust a time interval for a certain reference mark detected by the mark sensor 86 to reach the cutting mechanism 84 along the feeding path of the label base material S, whereby a target cutting position, which is set relative to the reference mark, matches an actual cutting position of the cutting mechanism 84.

The labels L cut from the label base material S by the cutting mechanism 84 are conveyed downwards sequentially by a suction type belt feeding mechanism 90 and received sequentially by a reservoir 92 at the bottom of the belt feeding mechanism 90. Subsequently, the labels L are conveyed to a bottle supply system which is not shown, where the labels are attached to the outer surface of a plurality of bottles automatically and sequentially.

As such, the Patent Document 1 discloses the label feeding device 80 that controls the feeding speed of the feeding mechanism 82 in accordance with the detection signal from the mark sensor 86 such that the actual cutting position of the cutting mechanism 84 is aligned with the target cutting position on the label base material S. As a result, the labels L can be cut out accurately even from a label base material S consisting of labels L of different lengths, as well as from a label base material S consisting of labels L of identical length.

Patent Document 1: Japanese Laid-Open No.2009-234649

In the label feeding device according to the Patent Document 1 described above, however, there is a case where the mark sensor 86 detects the reference mark when the base material S is in elastic deformation. Specifically, if the label base material S is stretched by tension in the upstream of the feeding mechanism 82, a distance between the reference marks of the labels on the label base material might be longer than the initial setting. In this case, an interval of time between detections of the detection signals output from the mark sensor 86 also gets longer, and the length of the labels cut by the cutting mechanism by controlling the feeding speed of the feeding mechanism based on the detected signals may be shorter than a desired length due to elastic shrinkage. This kind of situation is likely to occur especially for a highly stretchable label having an elastic deformation ratio of about 40%-50%.

Therefore, an object of the present invention is to provide a label producing device capable of accurately cutting out each label from a label base material on which highly stretchable labels are sequenced.

### SUMMARY OF THE INVENTION

A label producing device according to the present invention produces a plurality of labels sequentially by cutting an elongated label base material for each label while the label base material is conveyed in a longitudinal direction.

The label producing device includes: a cutting device for cutting the label base material for each label; a first feeding section including a first feed roller pair disposed upstream of the cutting device with respect to a conveying direction of the label base material for gripping the label base material, and a first feeding motor which rotates the first feed roller pair, the first feeding section feeding the label base material to the cutting means by rotating the first feed roller pair; a second feeding section including a second feed roller pair disposed further upstream of the first feeding section with respect to the conveying direction of the label base material for gripping the label base material, and a second feeding motor which rotates the second roller pair, the second feeding section feeding the label base material toward the first feeding section by rotating the second feed roller pair; a detection section which detects a reference mark of each label on the label base material between the first feeding section and the second feeding section; and a control section which controls respective operations of the cutting device, the first feeding section, and the second feeding section in accordance with a detection signal from the detection section, wherein the control section separately controls each of the operations of the first feeding motor and the second feeding motor such that the first feed roller pair and the second feed roller pair rotate synchronously.

In the label producing device according to the present invention, the label base material is conveyed intermittently by repeating progress and stop, and the plurality of labels are produced by cutting the label base material with the cutting device while the label base material is stopped, and the control section may control the operations of the first feeding motor and the second feeding motor such that a feeding amount of the label base material by the second feed roller pair is shorter than that by the first feed roller pair.

In the label producing device according to the present invention, the control section may control the operation of the second feeding motor such that a tensile force is applied to the label base material disposed between the first feed roller pair and the second feed roller pair, when the label base material is cut by the cutting device while conveyance of the label base material is stopped.

The label producing device according to the present invention further includes a conveying roller pair disposed downstream of the cutting device with respect to the conveying direction of the label base material and conveying the cut labels with the end of the label base material fed from the first feed roller pair being gripped by the conveying roller pair, and a conveying motor which rotates the conveying roller pair, wherein the control section controls the conveying motor at the same condition as the first feeding motor.

In the label producing device according to the present invention, the detecting section detects the reference mark of the each label on the label base material which is gripped and conveyed between the first and second feeding sections, both feeding sections operating synchronously, and the labels are cut and produced in accordance with the detection signal. Since the second feeding section grips the label base material between the rollers, the label base material located upstream of these rollers is not affected by variations in tensile force, and an interval of positions of the reference marks on the labels can be detected accurately with respect to the label base material which is being pulled adequately tightly between the first feeding section and the second feeding section. As a result, the cutter controlled in accordance with the detection signal from the mark sensor can cut out the labels from the label base material accurately for a desired length.

### BRIEF DESCRIPTION OF THE DRAWING(S)

FIG. 1 is an overall illustrative view of a label attachment system including a label producing device according to an embodiment of the present invention;

FIG. 2 is a side view showing a label producing device and a label feeding device;

FIG. 3 shows a first feed roller pair, a second feed roller pair, and a conveying roller pair;

FIG. 4 is a plan view showing a structure of a label base material;

FIG. 5 shows a major part of a feed belt;

FIG. 6 shows a structure of a take-up portion, in which (a) is a side view of the take-up portion and (b) is a perspective view showing how the take-up portion sucks a label;

FIG. 7 shows a structure of a receiving portion of the label attachment system, in which (a) shows the receiving portion gripping a label with a gripping element, and (b) shows a sheet type label being opened into a tubular shape;

FIG. 8 shows how the take-up portion passes a label to the receiving portion;

FIG. 9 shows an electrical configuration of the label attachment system;

FIG. 10 is a flowchart showing a control operation of a control device;

FIG. 11 is a timing diagram showing the control operation shown in FIG. 10; and

FIG. 12 shows a conventional label supplying device.

### DETAILED DESCRIPTION OF EXAMPLE EMBODIMENTS

An embodiment of the present invention (referred to as an embodiment hereinafter) will be described below with reference to the attached drawings. In the following description, a particular shape, materials, figures, directions, etc. disclosed herein are only illustrative for the purpose of facilitating the understanding of the present invention, and may be changed when deemed appropriate depending on applications, objects, and specifications, etc.

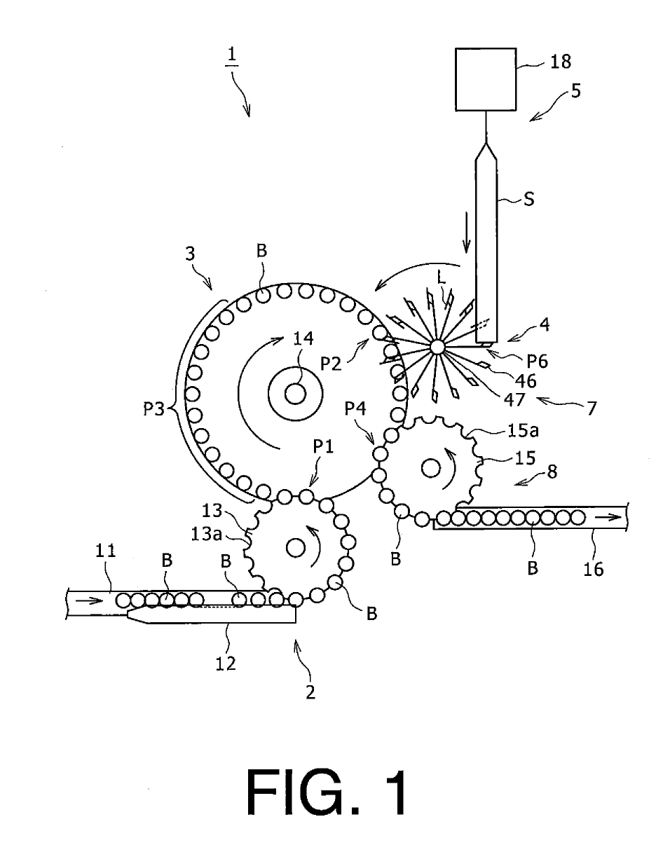

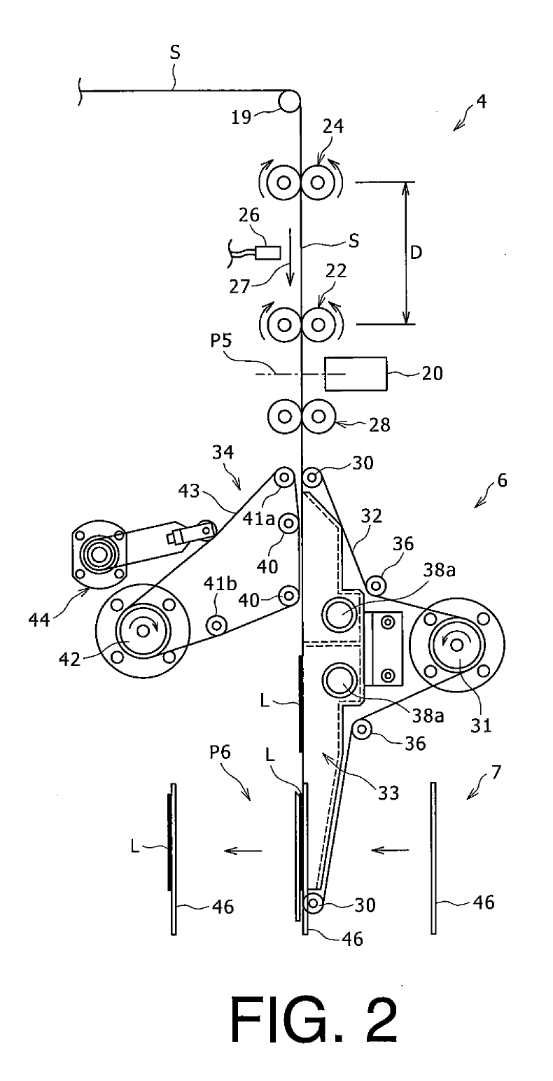

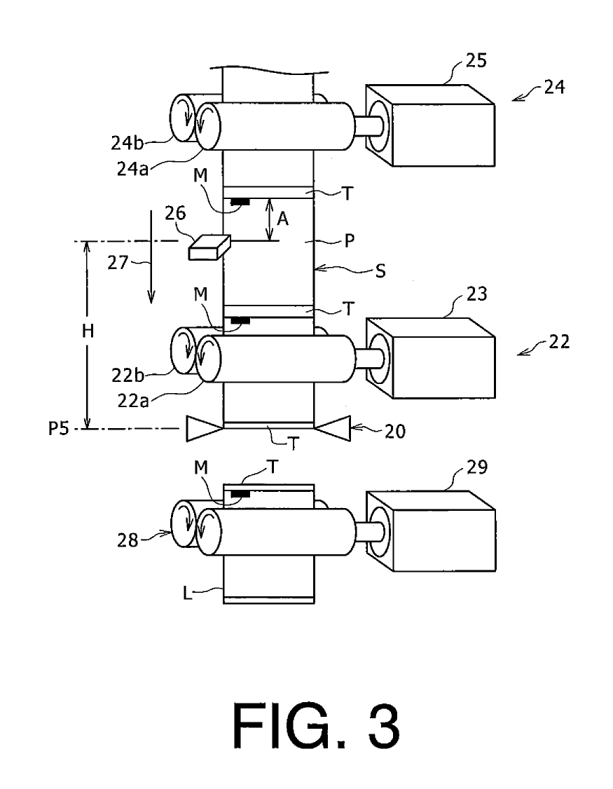

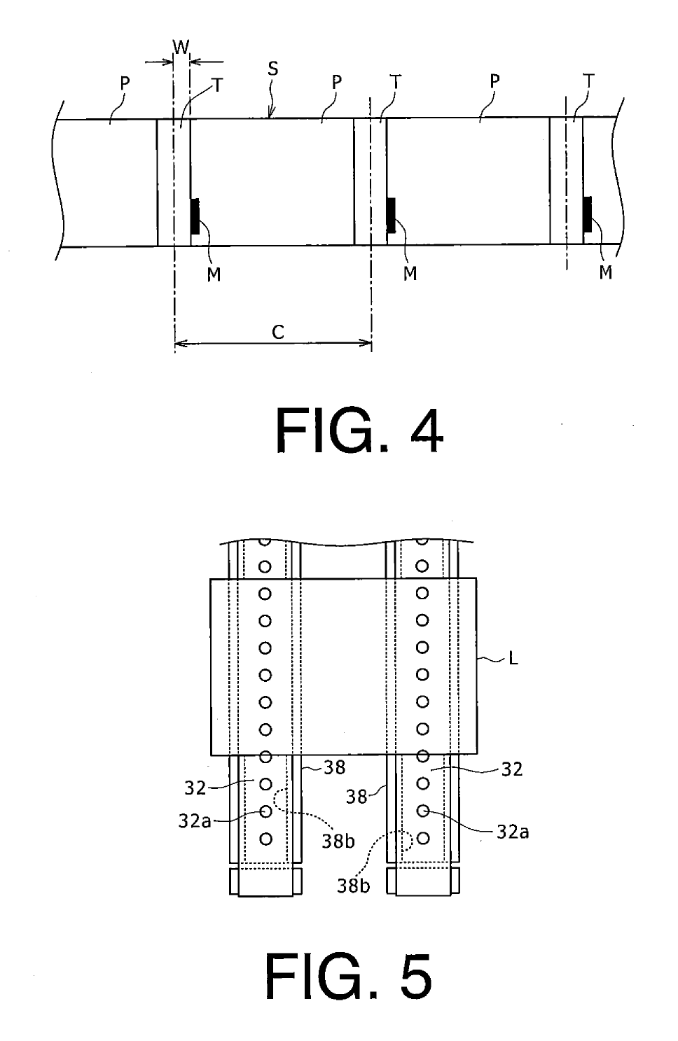

FIG. 1 is an overall illustrative view of a label attachment system 1 including a label producing device 4 according to an embodiment of the present invention. FIG. 2 shows a structure of the label producing device 4 and a label feeding device 6 in the label attachment system 1. FIG. 3 shows a major part of the label producing device 4. FIG. 4 is a plan view showing a configuration of a label base material S.

The label attachment system 1 is used to attach a tubular stretch label L (simply referred to as a label hereinafter, if appropriate) on which a name, for example, of a soft drink to be poured into a PET bottle, is written, to the surface of the bottle. In the label attachment system 1, while many bottles B to be conveyed are arranged in a line, an elongated label base material S having many labels printed thereon at predetermined intervals is pulled out and cut into individual labels L. These labels L are fed sequentially to a feeding path of the bottles B, where the labels L are attached to each bottle B at a predetermined position in the feeding path.

As shown in FIGS. 1 and 2, the label attachment system includes: a bottle supplying device 2 for supplying a bottle B to a label attachment device 3; the label attachment device 3 for attaching a label L on the bottle B supplied from the bottle supplying device 2; a label base material supplying device 5 for pulling an elongated label base material S to supply it to the label producing device 4; the label producing device 4 for producing a label L by cutting the elongated label base material S supplied from the label base material supplying device 5 while the label base material S is fed intermittently; a label feeding device 6 for feeding the label L produced by the label producing device 4 downwards, with the label L being sucked to the label feeding device 6; a label delivering device 7 for delivering the label L received from the label feeding device 6 to the label attachment device 3; and a bottle conveying device 8 for conveying the bottle B with the label L to a downstream process.

Since FIG. 1 is a plan view, the label base material S is provided in an approximately horizontal direction from the label base material supplying device 5 and conveyed vertically on the page relative to the label producing device 4 and the label feeding device 6 (see FIG. 2). In the feeding path of the label base material S, a fold changing device which is not shown in the figure is provided on the way. The fold changing device changes the position of a fold of the sheet-like label base material S that is pulled out from a base material pulling out portion 18 (see FIG. 1) of the label base material supplying device 5, whereby the label L can be opened into a tubular shape easily when applied to the bottle B.

The bottle supplying device 2 conveys a plurality of empty bottles B to the label attachment device 3. The bottle supplying device 2 comprises a conveyor 11, a screw conveyor 12, and a star-shaped wheel 13.

The conveyor 11 is driven by a conveying motor 64 which will be described below, and the screw conveyor 12 is connected to a main axis 14 which will also be described below to convey the plurality of bottles B. Specifically, the conveyor 11 conveys those bottles arranged in a line, and the screw conveyor 12 adjusts intervals between the bottles B such that they are arranged at predetermined intervals. The predetermined intervals are almost equal to the intervals between multiple recesses 13a formed on the periphery of the star-shaped wheel 13 to hold the bottles B.

The star-shaped wheel 13 rotates in synchronism with the main axis 14 of the label attachment device 3 to hold the plurality of bottles B around the periphery of the wheel at regular intervals, and conveys them to the label attachment device 3. Specifically, the star-shaped wheel 13 holds the bottles B which are conveyed by the conveyor 11 and the screw conveyor 12 in each of the bottle holding recesses 13a.

The label attachment device 3 holds the bottles B supplied from the bottle supplying device 2 and conveys them in a circumferential direction, during which the labels L are received from the label delivery device 7 and fitted to the bottles B, and the bottles B with the labels L are then delivered to the bottle conveying device 8.

The label attachment device 3 includes a plurality of label attachment heads, which are not shown, for holding the bottles B, and the main axis 14 on which the plurality of label attachment heads are installed radially at regular intervals. The interval of the label attachment heads is approximately equal to that of the recesses 13a of the star-shaped wheel 13. The label attachment heads are rotated in accordance with the rotation of the main axis 14 in a direction indicated by an arrow by a main axis motor 62 which will be described below. It is to be noted that the rotational speed of the label attachment heads is controlled by a main controller 60 which will be described below and is subject to change depending on the production amount of the bottles B. Each of the label attachment heads has a label fitter which is not shown. The label fitter fits the label L received from the label delivery device 7 over the bottle B from above. In FIG. 1, the labels L are fitted on the bottles B in a direction proceeding from the top to the bottom of the figure when seen in a vertical direction.

The label attachment device 3 receives the bottles B from the bottle supplying device 2 at a bottle delivery position P1 and conveys them in a circumferential direction while holding them in the label attachment heads. The label attachment device 3 receives the labels L at a label delivery position P2 from the label delivery device 7 and attaches them to the bottles B using the label fitter at a label attachment position 23 while the labels move around the main axis 14 in a direction indicated by an arrow. The label attachment device 3 then delivers the bottles B with the labels L at to the bottle conveying device 8 a delivery position P4.

The bottle conveying device 8 receives the bottles B with the labels L from the label attachment device 3 and advances them to downstream processes including examination, packaging, etc. The bottle conveying device 8 includes a star-shaped wheel 15 and a conveyor 16. With respect to the label attachment device 3, the bottle supplying device 2 is located at the input side of the bottles B, and the bottle conveying device 8 is located at the output side of the bottles B.

The star-shaped wheel 15 of the bottle conveying device B is rotated in synchronism with the main axis 14 of the label attachment device 3 in a direction indicated by an arrow, and holds the bottles B received from the label attachment heads of the label attachment device 3 to pass them to the conveyor 16. Bottle holding recesses 15a formed on the periphery of the star-shaped wheel 15 are disposed at regular intervals equal to the intervals of the label attachment heads of the label attachment device 3. The conveyor 16 is driven by a conveying motor 66 which will be described below and advances the bottles B received from the star-shaped wheel 15 to the downstream process

As shown in FIG. 4, a label base material S is formed by sequentially connected approximately tubular labels L to be attached on the bottles B. The label base material S (or each label L) is composed of a highly stretchable film having a thickness from 20 μm to 80 μm and being made of a highly stretchable polyethylene resin material having an elastic deformation rate from about 40% to 50%, for example. “The elastic deformation rate from 40% to 50%” as used herein means that an instantaneous strain of the material after being stretched from 40% to 50% does not exceed 10.5%, and “highly stretchable” means an easy-to-stretch characteristic of a material having a. tensile stress of no more than 7.7N/mm2 when the material is stretched by 60%. The label base material S is folded in a generally sheet-like manner and wound around a reel for the base material, for example, which is not shown at the base material pulling portion 18 of the label material supplying device 5 (see FIG. 1). Hereinafter, the labels L connected to each other on the label base material S will be referred to as “printed labels PL” in order to differentiate the labels L connected to each other on the label base material S from the label L which has been cut from the label base material S.

The label base material S is formed by sequentially connected printed labels PL, each printed label PL having a printed portion P on which a name of the bottle B or the like is printed, and a transparent portion T located between the printed portions P. Usually, the label base material S is cut at approximately the center of the transparent portion T (along a dot-dash line of FIG. 4) into a plurality of labels L. A length of the printed label PL cut along the centerline of the transparent portion T on both sides of the label will be referred to as a “cut length” hereinafter (indicated by C in FIG. 4). Alternatively, the label base material S may be formed by sequentially arranged printed portions P alone with no transparent portions T.

A rectangular reference mark M, for example, is formed at an appropriate position in each printed label PL. The reference mark M is detected by a mark sensor 26 which will be described below and is used as a reference position in cutting of the label base material S by the label producing device 4. The reference mark M is not limited to the rectangular shape, and all or part of a design, letters, or a symbol drawn in the printed label PL (a part of a certain shape, for example) may be used instead. Further, the position of the reference mark M to be formed on the printed label PL is not limited to the position shown in FIG. 4, and may be formed near the center or near the right end of the printed label PL. Further, if the mark sensor 26 can detect a border line between the printed portion P and the transparent portion T, such a border line may be used as the reference mark M.

The label base material supplying device 5 feeds the elongated label base material S pulled out of the base material pulling out portion 18 to the label producing device 4 sequentially at a predetermined speed. As shown in FIG. 2, the label base material S pulled out of the label supplying device 5 is wound around a support member 19 for only about ¼ of the circumference to change the feeding direction, for example, from a horizontal direction to a vertically downward direction. The support member 19 may be formed by a metal round bar material having a smooth outer surface. In this case, the label base material S is sequentially conveyed in sliding contact with the support member 19.

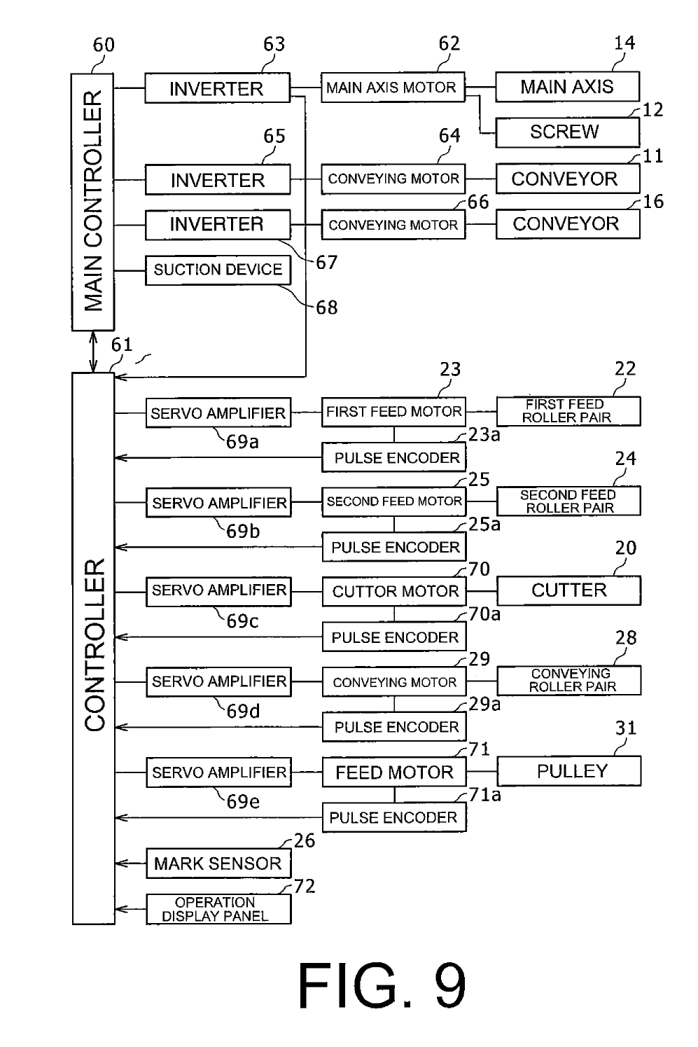

The label producing device 4 produces a plurality of labels L of a predetermined length by sequentially cutting the label base material S supplied from the label base material supplying device 5. As shown in FIGS. 2 and 3, the label producing device 4 includes a cutter 20 for cutting the label base material S into the labels L, a first feeder (a first feeding section) 22 and a second feeder (a second feeding section) 24 for feeding the label base material S to the cutter 20, a mark sensor (a detecting section) 26 for detecting the reference mark M of each label L on the label base material S between the first and second feeders 22, 24, and a controller 61 which will be described below (see FIG. 9) for controlling each of the operations of the cutter 20, the first and second feeders 22, 24, etc. in accordance with the detection signal from the mark sensor 26.

The cutter 20 cuts the elongated label base material S into a plurality of labels L. The cutter 20 can cut the label base material S conveyed downwards by the first feeder 22 at a cutting position P5 indicated by a dot-dash line. The cutter 20 may be made of a rotating blade and a fixed blade, as mentioned in the conventional technique. Alternatively, a rotating disk-like blade may be provided to move in a revolving manner in an approximately horizontal direction in order to cut the label base material S each time the blade revolves, or the label base material S may be pinched by two blades from both sides, just like scissors, and cut from one side to the other side. The cutting timing is controlled by the controller 61 which will be described below and is synchronized with the first feeder 22 such that the label base material S is fed from the first feeder 22 intermittently and cut sequentially to produce the labels L of the predetermine length.

The first feeder 22 is arranged upstream of the cutter 20 and feeds a predetermined length of the label base material S intermittently toward the cutter 20 in a feeding direction indicated by an arrow 27. The first feeder 22 includes a feed roller pair consisting of a driving roller 22a and a follower roller 22b, both rollers being in contact with each other under pressure, and a first feeding motor 23 coupled to the driving roller 22a. The label base material S is gripped tightly between the two rollers 22a, 22b so as not to slip. Gears of the driving roller 22a and the follower roller 22b provided at the ends of the respective rollers are in mesh with each other. Thus, as the driving roller 22a is rotated by the first feed motor 23, the follower roller 22b is also rotated at the same speed as the driving roller 22a by the engagement of gears, whereby the label base material S gripped between the rollers is sent toward the cutter 20. The driving roller 22a and the follower roller 22b will be referred to as a first feed roller pair 22a, 22b, if appropriate, hereinafter.

The second feeder 24 is provided upstream of the first feed roller pair 22a, 22b by a predetermined distance. The predetermined distance may be, but is not limited to, about twice as long as the cut length C of the label L (see FIG. 4), for example.

The second feeder 24 is formed like the first feeder 22. Specifically, the second feeder 24 feeds a predetermined length of the label base material S intermittently to the first feeder 22 and the cutter 20 along the feeding direction indicated by the arrow 27. The second feeder 24 includes a feed roller pair consisting of a driving roller 24a and a follower roller 24b, both rollers being in contact with each other under pressure, and a second feeding motor 25 coupled to the driving roller 24a. The label base material S is gripped tightly between the two rollers 24a, 24b so as not to slip. Gears of the driving roller 24a and the follower roller 24b provided at the ends of the respective rollers are in mesh with each other. Thus, as the driving roller 24a is rotated by the second feed motor 25, the follower roller 24b is also rotated at the same speed as the driving roller by the engagement of gears, whereby the label base material S gripped between the rollers is sent toward the first feeder 22 and the cutter 20. The second feeder 24 is controlled by the controller 61 in perfect or nearly perfect synchronism with the first feeder 22. The driving roller 24a and the follower roller 24b will be referred to as a second feed roller pair 24a, 24b, if appropriate, hereinafter.

It is to be noted that the second feeder 24 may be installed on a fixture such as a frame of the device such that a distance D from the first feeder 22 can be adjusted corresponding to a change of the cut length C of the label L of the label base material S.

The mark sensor 26 detects the reference mark M formed on each printed label PL of the label base material S between the first feeder 22 and the second feeder 24. The mark sensor 26 is placed almost in the middle of a distance from the first feed roller pair 22a, 22b to the second feed roller 24a, 24b. However, the setting of the position or height of the mark sensor 26 may change, if appropriate, as long as the mark sensor 26 is placed between the first feed roller pair 22a, 22b and the second feed roller pair 24a, 24b. Further, the mark sensor 26 may be installed on a fixture such as a frame of the device such that the setting position of the mark sensor 26 can be adjusted corresponding to a change of the cut length C of the label L.

The mark sensor 26 detects the presence of the reference mark M optically, for example, and a reflecting type mark sensor or a transmitting type mark sensor is used herein. A detection result of the mark sensor 26 is supplied to the controller 61 which will be described below, where the detection timing of the reference mark M on the each printed label PL is recognized.

The label producing device 4 further includes a conveying roller pair 28 and a conveying motor 29 for rotating the conveying roller pair 28, both being disposed downstream in the conveying direction of the label base material (see the arrow 27) subsequent to the cutter 20. The conveying roller pair 28 delivers to the downstream label feeding device 6 the labels L cut by the cutter 20 with the lower end of the label base material S gripped between the rollers. The conveying roller pair 28 and the conveying motor 29 are formed like the first feeder 22, and controlled under the same conditions as the first feeder 22 by the controller 61 which will be described below.

The control of operations of the cutter 20, the first feeder 22, and the second feeder 24 by the controller 61 will be described in detail below.

As shown in FIG. 2, the label feeding device 6 disposed below the label producing device 4 moves the labels L produced by the label producing device 4 sequentially to a label delivery position P6. The label feeding device 6 includes a guide roller 30 disposed in the vicinity of the conveying roller pair 28 and at the label delivery position P6, respectively; a pulley 31 which rotates in a direction indicated by an arrow by a feed motor 71 which will be described below; two feed belts 32 wound around the pulley 31; a suction mechanism 33 for holding the label L on the feed belt 32 by suction; and a suction supporting portion 34 for supporting the operation of the suction mechanism 33 to hold the label L on the feed belt 32 by suction by gradually fitting the label L tightly from the lower end to the upper end of the label L against the feed belt 32.

The two feed belts 32 are placed under tension by tension rollers 36 and driven by the feed motor 71 to circulate within a space between the vicinity of the conveying roller pair 28 and the label delivery position P6 at a speed faster than supply of the label base material S by the label base material supplying device 5. As shown in FIG. 5, the feed belts 32 are arranged parallel to each other in a vertical direction at a distance narrower than the width of the label L to be conveyed, with each feed belt 32 having a plurality of suction holes 32a formed in a longitudinal direction at regular intervals in the center part of the width of each feed belt 32.

The suction mechanism 33 is formed by suction chambers 38, each of which is disposed between the guide rollers 30, 30 along each feed belt 32, and a suction device 68 (described below) such as a compressor coupled to the suction chambers 38 through a connection inlet 38a by a tube or the like which is not shown. Each suction chamber 38 has a suction opening 38b formed in a surface which is in contact with the feed belt 32.

The suction supporting portion 34 is provided opposite to the feed belts 32 across the feeding path of the label L, and is formed by a belt 43 wound around a pulley 42 driven by a mother which is not shown, a pair of pressure rollers 40, and two guide rollers 41a, 41b, and a tension applying mechanism 44 for applying a tension to the belt 43. The rotating belt 43 driven by the pulley 42 in a direction indicated by an arrow is set to circulate at the same speed as the feed belt 32. The pressure rollers 40 press the label L against the feed belt 32 via the belt 43 in order to closely fit the label L against the feed belt 32 supplied from the conveying roller pair 28.

It is to be noted that the label feeding device 6 may transport the labels L in an approximately horizontal direction instead of the vertical direction. In this case, the bottles B will be conveyed in an approximately vertical direction instead of the approximately horizontal direction in the label attachment device 3. Also, the label feeding device 6 may transport the labels L by pinching them with a pinching device, for example, which is not shown, instead of conveying the labels using the suction force.

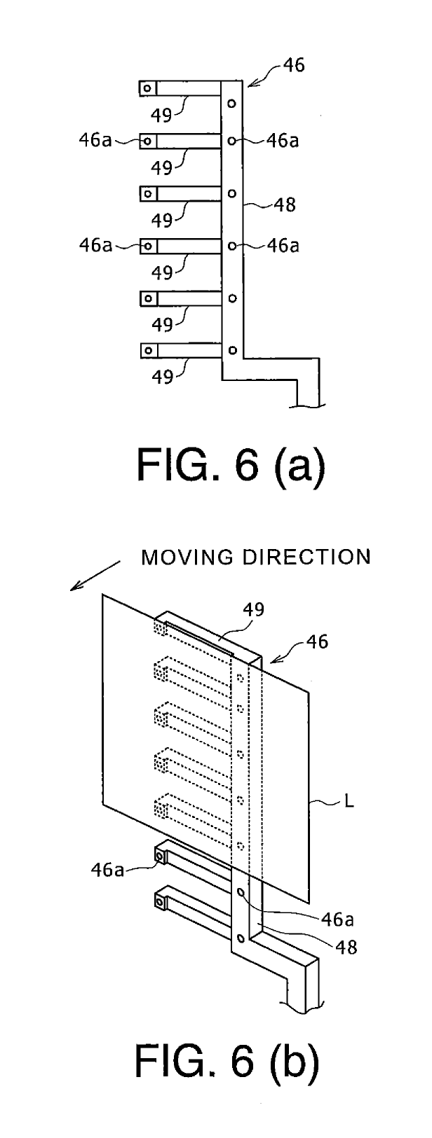

The label delivery device 7 receives the labels L at the label delivery position P6 from the label feeding device 6 to pass them to the label delivery position P2 of the label attachment device 3 as shown in FIG. 1. The label delivery device 7 includes a plurality of take-up members 46 for holding the labels L by suction and rotating axes 47 for supporting them in a radial manner. As shown in FIG. 6(a), each take-up member 46 has a base 48 extending vertically and a plurality of arms 49 protruding horizontally from the base 48. On the surface of the each arm 49 of the take-up member 46, a suction inlet 46a is formed and coupled to the suction device 68 which will be described below. As shown in FIG. 6(b), the take-up members 46 convey the received labels L while holding them using the suction force from the suction device 68.

The rotating axes 47 of the label delivery device 7 (see FIG. 1) are coupled to the main axis 14 of the label attachment device 3 controlled by the main controller 60 described below via engagement with gears, which are not shown, and rotated together with and in synchronism with the main axis 14. As shown in FIG. 2, as the rotating axes 47 are driven, the take-up members 46 are moved in an approximately horizontal direction to receive the labels L sequentially at the label delivery position P6.

In normal operation of the system, the timing to deliver the labels L to the label delivery position P6 of the feed belt 32 by the label feeding device 6 and the timing to receive the labels L by the take-up members 46 are set synchronously. Specifically, when the label feeding device 6 delivers the labels L to the label delivery position P6, the take-up members 46 receive the labels L sequentially.

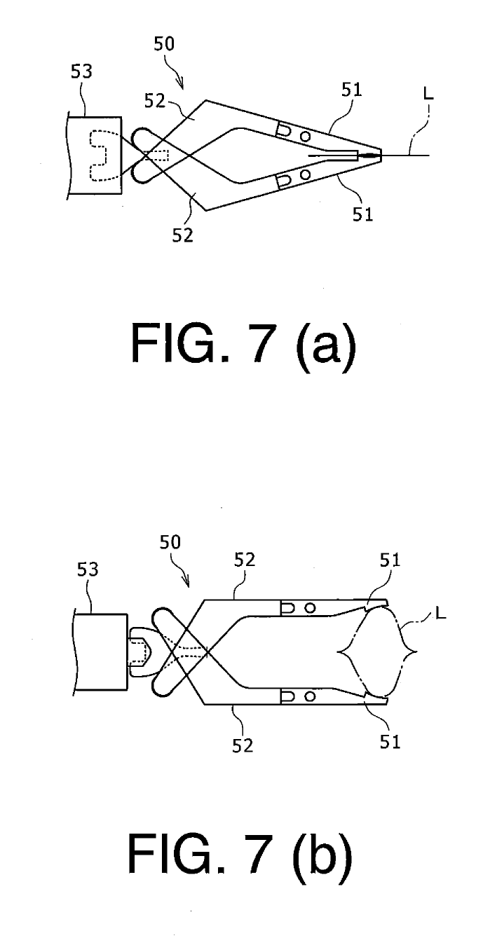

The labels L transported by the take-up members 46 are passed to the label attachment device 3 at the label delivery position P2 as shown in FIG. 1. As shown in FIG. 7 (an overhead view), a receiving portion 50 for receiving the labels L transported by the take-up members 46 is provided on each label attachment head of the label attachment device 3. The receiving portion 50 is formed by a pair of swing arms 52, 52 capable of opening and closing and having grippers 51, 51 attached to the tip end of the arms, an opening/closing device 53, and a suction device, which is not shown, for holding the label L gripped by the grippers 51, 51 by suction. FIG. 7 (a) shows how the grippers 51 grip the label L, and FIG. 7 (b) shows the open state of the sheet-like label L opened into a tubular shape.

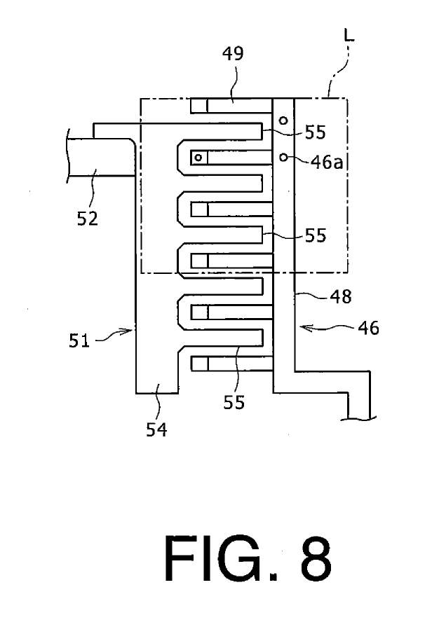

As shown in FIG. 8 (a side view), the grippers 51 are formed by a base 54 extending vertically, and a plurality of gripping arms 55 extending in an approximately horizontal direction from the base 54. As shown in FIG. 8, the receiving portion 50 receives the label L conveyed by the take-up member 46 at the label delivery position P2, with one side of the label held by suction, while the gripping arms 55 are separated from and in mesh with the arms 49 of the take-up member 46 to hold the label L. The label L opened by the receiving portion 50 is fitted to the bottle B from above by the label fitter at the label attachment position P3 as shown in FIG. 1. It is to be noted that the labels L may be delivered directly from the label feeding device 6 to the label attachment device 3 without using the label delivery device 7.

FIG. 9 is a block diagram showing an electrical configuration of the label attachment system 1. The label attachment system 1 includes a main controller 60 and a controller 61 (a control section) connected to the main controller 60, where data and control signals, etc. regarding the label attachment operation are communicated between the main controller 60 and the controller 61.

The main controller 60 generally controls the label attachment system. An inverter 63 for driving a main axis motor 62 which rotates the main axis 14 of the label attachment device 3 is connected to the main controller 60. When the main controller 60 outputs a control signal to the inverter 63 to rotate the main axis motor 62, the inverter 63 outputs a drive signal to the main axis motor 62 to rotate the same, whereby the main axis 14 and the screw conveyor 12 are rotated.

Also, an inverter 65 for driving a conveying motor 64 which operates the conveyor 11 of the bottle supplying device 2 is connected to the main controller 60. When the main controller 60 outputs a control signal to the inverter 65 to operate the conveyor 11, the inverter 65 outputs a drive signal to the conveying motor 64 to rotate the same, whereby the conveyor 11 conveys the bottles B to the label attachment device 3.

Further, an inverter 67 for driving a conveying motor 66 which operates the conveyor 16 of the bottle conveying device 8 is connected to the main controller 60. When the main controller 60 outputs a control signal to the inverter 67 to operate the conveyor 16, the inverter 67 outputs a drive signal to the conveying motor 66 to rotate the same, whereby the conveyor 16 conveys the bottles B to the downstream process which is not shown.

The main controller 60 is capable of changing the rotational speed of the main axis motor 62 and the conveying motors 64, 66, and the bottle supplying speed of the bottles B is changed in accordance with the change of the rotational speed. Since the rotating axes 47 of the label delivery device 7 are rotated with the main axis 14 driven by the main axis motor 62, if the rotational speed of the main axis 14 is changed by the main controller 60, the rotational speed of the rotating axes 47 is also changed synchronously.

The suction device 68 for holding the labels L on the feed belt 32 by suction and for allowing the take-up members 46 to suck the labels L is connected to the main controller 60. The suction device 68 is controlled by a control signal from the controller 61.

The controller 61 includes a microcomputer which is not shown and controls each of the operations of the cutter 20, the first feeder 22, the second feeder 24, and the conveying roller pair 28 of the label producing device 4 in accordance with an instruction from the main controller 60 and a previously stored operation program. The controller 61 has a memory, which is not shown, for storing various types of data.

The inverter 63 connected to the main controller 60 is also connected to the controller 61 which constantly recognizes the rotational positions of the label attachment heads of the label attachment device 3 by receiving a detection signal of a main axis encoder, which is not shown, from the inverter 63. Specifically, the main axis encoder outputs a predetermined number of pulses (e.g., 5,000 pulse) to the controller 61 during movement of a particular bottle B conveyed by the label attachment device 3 from the current position to the position of another bottle B which is immediately preceding the particular bottle B. The controller 61 controls a cutter motor 70 of the cutter 20 by determining a timing to cut the label base material S by the cutter 20 in accordance with the reference pulses. Also, the controller 61 constantly recognizes the rotational positions of the take-up members 46 of the label delivery device 7 by receiving the detection signal from the main axis encoder.

A servo amplifier 69a for controlling the first feed motor 23 which drives the first feed roller pair 22a, 22b is connected to the controller 61. When the controller 61 outputs a control signal to rotate the first feed roller pair 22a, 22b to the servo amplifier 69a, a drive signal is output from the servo amplifier 69a to the first feed motor 23, whereby the first feed motor 23 is driven to rotate the first feed roller pair 22a,22b. The controller 61 receives a detection signal from a pulse encoder 23a attached to the first feed motor 23.

A servo amplifier 69b for controlling the second feed motor 25 which drives the second feed roller pair 24a, 24b is connected to the controller 61. When the controller 61 outputs a control signal to rotate the second feed roller pair 24a, 24b to the servo amplifier 69b, a drive signal is output from the servo amplifier 69b to the second feed motor 25, whereby the second feed motor 25 is driven to rotate the second feed roller pair 24a,24b. The controller 61 receives a detection signal from a pulse encoder 25a attached to the second feed motor 25. As such, the second feed roller pair 24a, 24b can be controlled independently of the first feed roller pair 22a, 22b.

A servo amplifier 69c for controlling the cutter motor 70 which drives the cutter 20 is connected to the controller 61. When the controller 61 outputs a control signal to operate the cutter 20 to the servo amplifier 69c, a drive signal is output from the servo amplifier 69c to the cutter motor 70, whereby the cutter 20 is operated to cut out the labels L. The controller 61 receives a detection signal from a pulse encoder 70a attached to the cutter motor 70.

A servo amplifier 69d for controlling the conveying motor 29 which drives the conveying roller pair 28 is connected to the controller 61. When the controller 61 outputs a control signal to rotate the conveying roller pair 28 to the servo amplifier 69d, a drive signal is output from the servo amplifier 69d to the conveying motor 29, whereby the conveying motor 29 is driven to rotate the conveying roller pair 28. The controller 61 receives a detection signal from a pulse encoder 29a attached to the conveying motor 29. As such, the conveying roller pair 28 can be controlled independently of the first feed roller pair 22a, 22b and the second feed roller pair 24a, 24b. However, if the conveying roller pair 28 is driven under the same conditions as the first feed roller pair 22a, 22b, or fully synchronously at the same speed, it is possible to transmit the rotation of the first feed motor 23 to the conveying roller pair 28 via a transmission means, such as a belt, and the conveying motor 29 may be removed.

A servo amplifier 69e for controlling the feed motor 71 which drives the pulley 31 wound by the feed belt 32 is connected to the controller 61. When the controller 61 outputs a control signal to rotate the pulley 31 to the servo amplifier 69e, a drive signal is output from the servo amplifier 69e to the feed motor 71, whereby the feed motor 71 is driven to rotate the pulley 31 which, in turn, circulates the feed belt 32. The controller 61 receives a detection signal from a pulse encoder 71a attached to the feed motor 71.

The controller 61 receives an output signal from the mark sensor 26 connected to the controller 61. It recognizes a timing of detection of the reference mark M in the printed label PL on the label base material S by the mark sensor 26 between the first feed roller pair 22a, 22b and the second feed roller pair 24a, 24b in accordance with the output signal from the mark sensor 26.

An operation display panel 72 for prompting an operator to enter various settings concerning the label attachment operation or displaying the status of the label attachment operation is connected to the controller 61. The operation display panel 72 has a touch-panel display. If the operator executes a predetermined operation on the touch-panel, a corresponding operation signal is output to the controller 61. Display data is input from the controller 61 to the operation display panel 72 and appears on the display in accordance with the display data.

The operator can set the cut length C mentioned above and an address length A from the operation display panel 72. As shown in FIG. 4, the cut length C is the length of the label L cut out from the label base material S in the middle of the transparent portion T provided between adjacent two labels L. The address length A is a distance A, as shown in FIG. 3, in a direction of conveying the labels between the reference mark M on the printed label PL and the detecting position of the mark sensor 26 in cutting the label base material S by the cutter 20.

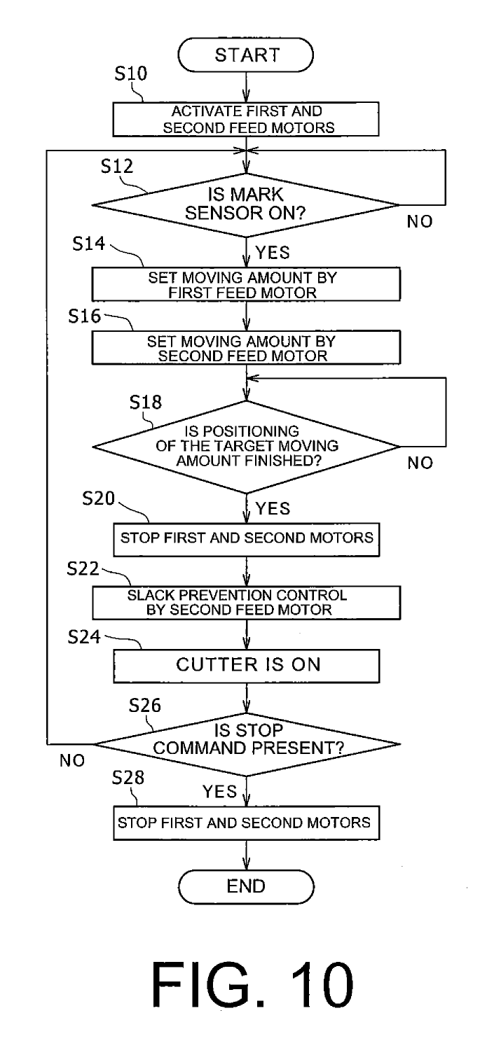

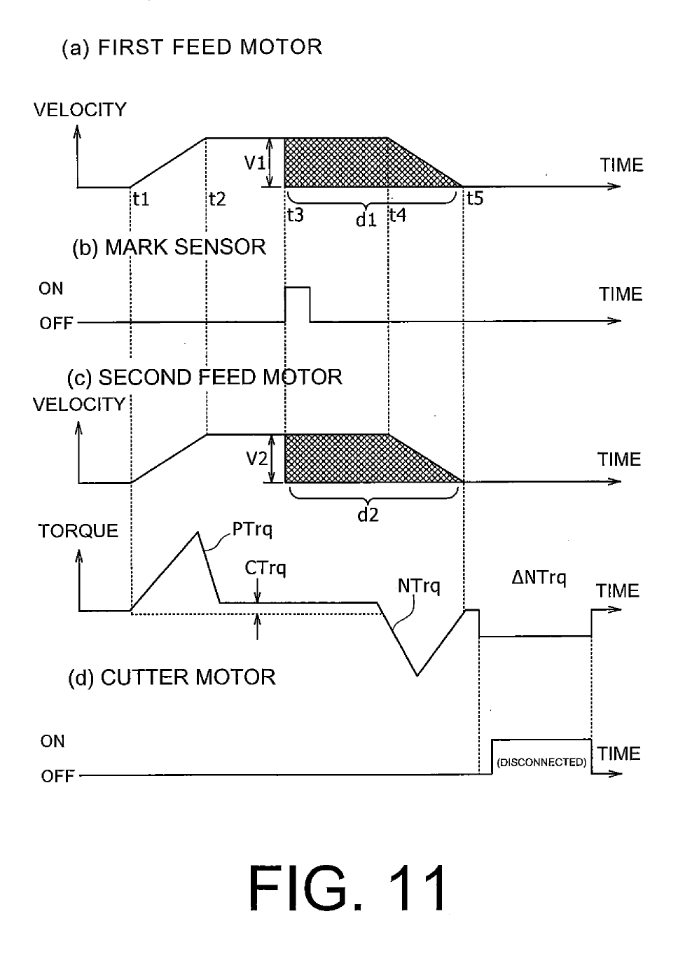

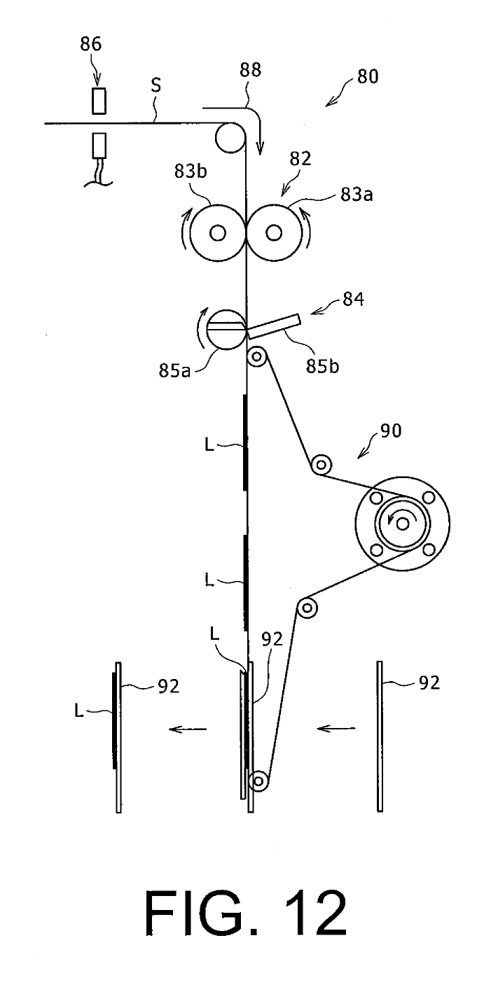

Now, with reference to FIGS. 10 and 11, a control operation of the label producing device 4 of the present embodiment will be described. FIG. 10 is a flowchart showing the control operation of the controller 61. The control operation shown in FIG. 10 is executed by reading a control program stored in a memory and processed by a microcomputer in the controller 61.

To activate the label attachment system 1, the operator sets the cut length C of the label L and the address length A on the operation display panel 72. In this case, the cut length C of the label L may be calculated for each label based on the actual measurement and averaging of 10 labels L, for example, of the label base material S set in the label base material supplying device 5. Alternatively, a predetermined label length already known may be used. The address length A may be a distance actually measured by the operator for a distance between the detecting position of the mark sensor 26 and the reference mark M of the label base material S located downstream of the detecting position when the label base material S is cut in the middle of the transparent portion T by the cutter 20. Alternatively, the address length A may be calculated if a distance between the cutter 20 and the mark sensor 26 in the conveying direction is known from the relative positions, and a half length W of the transparent portion T of the printed label PL (see FIG. 4) is also known. For example, in the example shown in FIG. 3, the address length is A=2C-H-W, where a distance H is a distance between the cutting position P5 of the cutter 20 and the detecting position of the mark sensor 26.

The control operation shown in FIG. 10 is started when the operator turns on an activation switch (not shown) of the system, with the end of the label base material S being cut as shown in FIG. 3. In step S10, the first feed motor 23 and the second feed motor 25 are started. In response to this, the first feed roller pair 22a, 22b and the second feed roller pair 24a, 24b are rotated respectively so that the label base material S starts to move toward the cutter 20.

In step S12, whether or not the mark sensor 26 is turned on, or whether or not the reference mark M on the printed label PL of the label base material S is detected is determined. If the reference mark M is detected by the mark sensor 26 (YES in the step S12), a conveying distance or a moving amount of the label base material S by each of the first feed motor 23 and the second feed motor 25 is set in the subsequent steps S14 and S16, respectively.

The setting of the moving amount of the label base material S by the first feed motor 23 is done as follows. Specifically, the controller 61 calculates the moving amount of the conveyed label base material S from the startup of the first feed motor 23 till the detection timing of the reference mark M by the mark sensor 26 in accordance with the number of pulses received from the pulse encoder 23a, and reduces this result from the cut length C to obtain the remaining moving amount of the label base material.

The second feed motor 25 sets the moving amount of the label base material similarly to the first feed motor 23. Specifically, the controller 61 calculates the moving amount of the conveyed label base material S from the startup of the second feed motor 25 till the detection timing of the reference mark M by the mark sensor 26 in accordance with the number of pulses received from the pulse encoder 25a, and reduces this result from the cut length C to obtain the remaining moving amount of the label base material. However, the moving amount of the label base material from startup to shutdown of the second feed motor 25 is set slightly shorter than the moving amount of the label base material set by the first feed motor 23, as described in detail below with reference to FIG. 11.

FIG. 11 is a timing diagram showing the control operation of FIG. 10 in relation to time (indicated by the horizontal axis). FIG. 11(a) shows the rotational speed or the conveying speed of the first feed motor 23. FIG. 11(b) shows the on/off state of the mark sensor 26. The upper diagram of FIG. 11(c) shows the rotational speed or the conveying speed of the second feed motor 25, and the lower diagram shows torque control of the second feed motor 25. FIG. 11(d) shows the operation state of the cutter motor 70 for cutting the label base material S during the on-state.

Referring to FIGS. 11(a) and (b), the rotation is started at time t1, and the speed is gradually increased to reach a fixed speed at time t2. During the fixed speed rotation, when the mark sensor 26 detects the reference mark M at time t3, the remaining moving amount of the label base material d1 is set as described above. The remaining moving amount d1 of the label base material S corresponds to an area indicated by cross-hatching in FIG. 11(a). Then, the first feed motor 23 starts to decrease the speed at time t4 and stops at time t5. It is to be noted that the remaining moving amount of the label base material d1 is shown in the figure with the rising edge of the detection signal from the mark sensor 26 serving as a starting point, but since a period of time of the actual detection signals is very short and should be indicated as a line, no substantial difference may occur if the falling edge of the detection signal is used to set the remaining moving amount of the label base material.

Referring to FIG. 11(c), the second feed motor 25 is controlled in synchronism with and in a similar way to the first feed motor 23, and the remaining moving amount d2 of the label base material S is set in accordance with the detection signal from the mark sensor 26. As shown in the lower diagram of FIG. 11(c), the second feed motor 25 is controlled in such a manner that a positive torque PTrq having a predetermined up and down periods is exerted during the increase of the speed, a constant torque CTrq is maintained during the constant speed, and a negative torque NTrq having a predetermined down and up periods is exerted during the decrease of the speed.

In FIG. 11(c), the remaining moving amount d2 of the label base material S shown by the area of the cross-hatching is set 0.05% shorter, for example, than the remaining moving amount D1 of the label base material S of the first feed motor 23 (i.e., d2=d1×0.9995). Specifically, this is realized by setting a velocity v2 of the second feed motor 25 during the constant speed rotation to be smaller than a velocity v1 of the first feed motor 23 during the constant speed rotation (v2<v1). The moving amount d2 of the label base material S by the second feed motor 25 is set to be shorter than the moving amount d1 of the label base material S of the first feed motor 23, so that the label base material S can be pulled adequately tightly between the first feed roller pair 22a, 22b and the second feed roller pair 24a, 24b. Herein, “pulled adequately tightly” means that the label base material S extends straightly in the conveying direction between the first feed roller pair 22a, 22b and the second feed roller pair 24a, 24b, with no slack or any significant elastic stretching in the base material.

With respect to the moving amount of the label base material after the mark sensor 26 detects the reference mark M, the moving amount by the second feed motor 25 is controlled to be shorter than that by the first feed motor 23, but the control is not limited to this and the entire moving amount of the label base material from the start of the motors 23, 25 (time t1) till the stop of the motors (time t5) may be set shorter for the second feed motor 25 than for the first feed motor 23.

Referring to FIG. 10 again, in the subsequent step S18, it is determined whether or not the positioning of the label base material S at the target moving amount has been done. The target moving amount corresponds to the remaining moving amount d1 of the label base material S by the first feed motor 23.

If the positioning of the target moving amount of the label base material S has been done (YES in the step S18), the first feed motor 23 and the second feed motor 25 are stopped in the subsequent step S20, and slack prevention control is executed for the second feed motor 25 in the further subsequent step 22.

As shown in the lower diagram of FIG. 11(c), in the slack prevention control for the second feed motor 25, a predetermined amount of negative torque ANTrq is exerted on the second feed motor 25 to pull the label base material S lightly in an upward direction by the second feed roller pair 24a, 24b, and this state is maintained till the cutting operation of the cutter 20 is finished. By doing this, slack in the label base material S between the first feed roller pair 22a, 22b and the second feed roller pair 24a, 24b during the cutting of the label base material S can be prevented, which facilitates the transport of the label base material S in a pulled-moderately-tightly state next time the transport of the label material S is started.

Referring to FIG. 10 again, in the subsequent step S24, the cutter motor 70 is activated to operate the cutter 20, whereby the label base material S is cut approximately at the center of the transparent portion T on the downstream side of the printed label PL located at the lower end of the label base material S, whereby the labels L are produced by cutting off from the label base material S. During the cutting, the lower end of the label L which is to be formed by cutting is gripped by the conveying roller pair 28 driven under the same conditions as the first feed roller pair 22a, 22b and held taut without slack. Thus, the cutter 20 can cut accurately.

The labels L produced by cutting are delivered to the label conveying device 6 below by the conveying roller pair 28.

In the subsequent step S26, the presence of a stop command is determined. If there is no stop command (NO in the step S26), the process returns to the step S12 and each of the steps S12 to S24 is repeated and the labels L are produced sequentially while the label base material S is conveyed intermittently. On the other hand, if the stop command is present (YES in the step S26), the first feed motor 23, the second feed motor 25, and the conveying motor 29, etc, are stopped, and the control operation is finished.

As described above, in the label producing device 4 of the present embodiment, the mark sensor 26 detects the reference mark of each printed label PL on the label base material S which is gripped and conveyed between the first feed roller pair 22a, 22b and the second feed roller pair 24a, 24b, both roller pairs operating synchronously, and the labels L are cut and produced sequentially in accordance with the detection signal. Since the second feed roller pair 24a, 24b grips the label base material S between them, the label base material S located upstream of these rollers is not affected by variations in tensile force, and an interval of positions the reference marks M on the printed labels PL can be detected accurately with respect to the label base material S which is being pulled moderately tightly between the first feeder 22 and the second feeder 24. As a result, the cutter 20 controlled in accordance with the detection signal from the mark sensor 26 can cut out the labels L from the label base material S accurately for the cut length C as determined in the setting.

Since the moving amount of the label base material by the second feed roller pair 24a, 24b is set to be shorter than that of the first feed roller pair 22a, 22b, and a weak tensile force sufficient to eliminate the slack in the label base material S disposed between these rollers is applied to it, it is ensured that the label base material S can be held in the pulled-moderately-tightly state between the first feeder 22 and the second feeder 24.

It will be understood that the structure or the like of the label producing device 4 is described in this embodiment, but the present invention is not limited thereto, and various modifications or variations are possible.

For example, since the different rotational speeds are set in the feed roller pairs during the fixed speed rotation, the second feed roller pair 24a, 24b is controlled to move a shorter amount of the label base material S than the first feed roller pair 22a, 22b in the above-described embodiment. Alternatively, the rotational speeds of the first feed roller pair 22a, 22b and the second feed roller pair 24a, 24b may be equal, while the timing of stopping the first feed motor is delayed a little from the stop timing of the second feed roller.

The conveying roller pair 28 provided downstream of the first feed roller pair 22a, 22b and below the cutter 20 is controlled in the same state as the first feed roller pair 22a, 22b in this embodiment. Alternatively, the conveying roller pair 28 may be controlled to move the label base material S slightly further than the first feed roller pair 22a, 22b, so as to apply a tensile force sufficient for cutting to the label base material S disposed between the first feed roller pair 22a, 22b and the conveying roller pair 28.

Also, a sensor for monitoring a motor current of the second feed motor 25 in the second feeder 24 may be provided. When the motor current exceeds a predetermined threshold value, the controller determines an unacceptable amount of elastic stretch being exerted on the label base material upstream of the second feeder 24 and warns the operator by sounding an alarm, for example.

### PARTS LIST

1: LABEL ATTACHMENT SYSTEM
2: BOTTLE SUPPLYING DEVICE
3: LABEL ATTACHMENT DEVICE
4: LABEL PRODUCING DEVICE
5: LABEL BASE MATERIAL SUPPLYING DEVICE
6: LABEL FEEDING DEVICE
7: LABEL DELIVERING DEVICE
11,16: CONVEYOR
12: SCREW CONVEYOR
13,15: STAR-SHAPED WHEEL
13a,14a: RECESS
14: MAIN AXIS
18: BASE MATERIAL PULLING OUT PORTION
19: SUPPORT MEMBER
20: CUTTER
22: FIRST FEEDER
22a: DRIVING ROLLER
22b: FOLLOWER ROLLER
23: FIRST FEED MOTOR
23a,25a,29a: PULSE ENCODER
24: SECOND FEEDER
24a: DRIVING ROLLER
24b: FOLLOWER ROLLER
25: SECOND FEED MOTOR
26: MARK SENSOR
28: CONVEYING ROLLER PAIR
29: CONVEYING MOTOR
30: GUIDE ROLLER
31: PULLEY
32: FEED BELT
32a: SUCTION HOLE
33: SUCTION MECHANISM
34: SUCTION SUPPORTING PORTION
36: TENSION ROLLER
38: SUCTION CHAMBER
38a: CONNECTION INLET
38b: SUCTION OPENING
40: PRESSURE ROLLER
41a,41b: GUIDE ROLLER
42: PULLEY
43: BELT
44: TENSION APPLYING MECHANISM
46: TAKE-UP MEMBER
46a: SUCTION INLET
47: ROTATING AXIS
48: BASE
49: ARM
50: RECEIVING PORTION
51: GRIPPER
52: SWING ARM
53: OPENING/CLOSING DEVICE
54: BASE
55: GRIPPING ARM
60: MAIN CONTROLLER
61: CONTROLLER
62: MAIN AXIS MOTOR
63,65,67: INVERTER
64,66: CONVEYING MOTOR
68: SUCTION DEVICE
69a,69b,69c,69d, 69e: SERVO AMPLIFIER
70: CUTTER MOTOR
70a,71a: PULSE ENCODER
71: FEED MOTOR
72: OPERATION DISPLAY PANEL
A: ADDRESS LENGTH
B: BOTTLE
C: CUT LENGTH
CTrq: CONSTANT TORQUE
D, H: DISTANCE
d1,d2: MOVING AMOUNT OF LABEL BASE MATERIAL
L: LABEL
M: REFERENCE MARK
NTrq, LNTrq: NEGATIVE TORQUE
P: PRINTED PORTION
P1: BOTTLE DELIVERY POSITION
P2: LABEL DELIVERY POSITION
P3: LABEL ATTACHMENT POSITION
P4: DELIVERY POSITION
P5: CUTTING POSITION
P6: LABEL DELIVERY POSITION
PL: PRINTED LABEL
PTrq: POSITIVE TORQUE
S: LABEL BASE MATERIAL
T: TRANSPARENT PORTION
t1-t5: TIME
v1,v2: VELOCITY

1. A label producing device for producing a plurality of labels sequentially by cutting an elongated label base material for each label while the label base material is being conveyed in a longitudinal direction, comprising:
a cutting device which cuts the label base material for each label;
a first feeding section including a first feed roller pair disposed upstream of the cutting device with respect to a conveying direction of the label base material for gripping the label base material, and a first feeding motor which rotates the first feed roller pair, the first feeding section feeding the label base material to the cutting section by rotating the first feed roller pair;
a second feeding section including a second feed roller pair disposed further upstream of the first feeding section with respect to the conveying direction of the label base material for gripping the label base material, and a second feeding motor which rotates the second roller pair, the second feeding section feeding the label base material toward the first feeding section by rotating the second feed roller pair;
a detection section which detects a reference mark of each label on the label base material between the first feeding section and the second feeding section; and
a control section which controls respective operations of the cutting device, the first feeding section, and the second feeding section in accordance with a detection signal from the detection means,
wherein the control section separately controls each of the operations of the first feeding motor and the second feeding motor such that the first feed roller pair and the second feed roller pair rotate synchronously.

2. A label producing device according to claim 1, wherein
the label base material is conveyed intermittently by repeating progress and stop, and the plurality of labels are produced by cutting the label base material with the cutting device while the label base material is stopped, and
the control section controls the operations of the first feeding motor and the second feeding motor such that a feeding amount of the label base material by the second feed roller pair is shorter than that by the first feed roller pair.

3. A label producing device according to claim 2, wherein
the control section controls the operation of the second feeding motor such that a tensile force is applied to the label base material disposed between the first roller pair and the second feed roller pair, when the label base material is cut by the cutting device while conveyance of the label base material is stopped.

4. A label producing device according to claim 1, further comprising:
a conveying roller pair disposed downstream of the cutting device with respect to the conveying direction of the label base material and conveying the cut labels with the end of the label base material fed from the first feed roller pair being gripped by the conveying roller pair, and a conveying motor which rotates the conveying roller pair,
wherein the control section controls the conveying motor under the same conditions as the first feeding motor.
